(19) United States
(12) Patent Application Publication
(10) Pub. No.: US 2007/0253770 A1
(43) Pub. Date: Nov. 1, 2007

(54) Joined connection, joining element and method for inserting a joining element into a component

(75) Inventor: Peter Strempel, Schwabach (DE)

Correspondence Address: LERNER GREENBERG STEMER LLP, P O BOX 2480, HOLLYWOOD, FL, 33022-2480, US

(73) Assignee: Richard Bergner Verbindungstechnik GmbH & Co. KG

(21) Appl. No.: 11/789,365

(22) Filed: Apr. 24, 2007

(30) Foreign Application Priority Data
Apr. 26, 2006 (DE) 10 2006 019 231.1

(51) Int. Cl. F16D 1/00

(52) U.S. Cl. 403/408.1

(57) ABSTRACT

In order to make a reliable form-fitting connection possible, in particular even in the case of a joined connection between a joining element and a component both made from stainless steel, axial securing is produced by partial shearing off and displacement of shaft material against a component underside. As a result, a reliable form-fitting connection is produced in press-in nuts or press-in bolts, despite low degrees of deformation.

### CROSS-REFERENCE TO RELATED APPLICATION

This application claims the priority, under 35 U.S.C. § 119, of German application DE 10 2006 019 231.1, filed Apr. 26, 2006; the prior application is herewith incorporated by reference in its entirety.

### BACKGROUND OF THE INVENTION

### Field of the Invention

The invention relates to a joined connection between a component and a joining element which is inserted into a component hole in a form-fitting manner, and to a joining element for a joined connection of this type. Furthermore, the invention relates to a method for inserting a joining element into a component hole of a component, the joining element which has a shaft region being inserted by way of the shaft region into the component hole and being pressed against a template in order to produce form-fitting axial securing.

Here, a joining element is understood to be, in particular, what are known as press-in nuts or else press-in bolts which are pressed into a component, in particular a metal sheet, in a form-fitting manner and to which further fastening elements such as screws and/or nuts can be fastened for fastening further components.

A joining element of this type can be gathered, for example, from published, European patent application EP 0 784 168 A1, corresponding to U.S. Pat. No. 5,819,591. In its head region, the riveting or press-in nut which is described in the above document has an annular collar which is adjoined by a sleeve-shaped shaft having an internal thread. The joining element is inserted into a preperforated component and a part of the shaft which protrudes beyond the underside of the component is deformed with the aid of a template, with the result that an annular projection which rotates on the underside of the component is formed on the joining element. In addition to the axial securing, radially extending web-like projections which are pressed into the component surface are provided on the underside of the collar as an antirotation safeguard.

The use of anti-corrosion steels, in particular what are known as stainless steels, for the metal sheets or components require that the joining elements are also formed from an anti-corrosion steel or stainless steel. However, in comparison with conventional steel joining elements, stainless steel joining elements have a lower degree of deformation and the stainless steel joining element can therefore be deformed only comparatively poorly. The geometries and deforming methods which are used in the case of conventional steel joining elements cannot therefore be transferred to stainless steel joining elements.

### SUMMARY OF THE INVENTION

It is accordingly an object of the invention to provide a joined connection, a joining element and a method for inserting a joining element into a component that overcome the above-mentioned disadvantages of the prior art device and method of this general type, which is based on the object of making a secure and reliable joined connection between the component and the joining element possible, in particular even if stainless steel joining elements are used.

With the foregoing and other objects in view there is provided, in accordance with the invention, a joined connection. The joined connection contains a component having a component hole and a component underside; and a joining element having shaft material and inserted into the component hole in a form-fitting manner. An axial form-fitting securing is produced by a partial shearing off of the shaft material of the joining element and displacement of the shaft material against the component underside of the component.

According to this, in order to produce an axially acting form-fitting connection between the joining element and the component, partial shearing off of shaft material and displacement of the shaft material against the component underside are provided.

Shearing off is understood as severing of the shaft material. Partial shearing off results in that the shaft material is not severed completely from the shaft region. Rather, a material-to-material connection remains on one side between the partially sheared off material and the remaining shaft material. The shape change of the shaft region in order to produce the form-fitting connection is therefore achieved by the fact that a template “cuts into” the shaft material only in the axial direction and at the same time the material which is sheared off partially in this way is displaced against the component underside. In contrast to the conventional deforming processes, partial material separation therefore takes place. This measure provides the possibility of a secure and reliable joined connection even in the case of stainless steel joining elements, despite an only low degree of deformation. The component is therefore pressed in between a head contact face of the joining element on the component surface and the shaft material which is pushed against the component underside.

According to one expedient development, a plurality of discrete securing lugs are produced in a manner which is distributed about the circumference by the shearing off. The shearing off therefore does not take place over the entire circumference, but only partially at discrete circumferential regions. This partial shearing off in the circumferential direction has the particular advantage that the required shearing force is kept low. At the same time, the shaft region is weakened by the shearing off of material only at individual discrete locations.

With regard to a simple pressing-in method, the shaft region has an external contour which deviates from a circular shape and has protruding shaped elements. The protruding shaped elements are sheared off partially. It is therefore possible in this configuration variant to produce the individual securing lugs which are distributed around the circumference by the shearing off in a simple manner by way of a supporting device or template of circularly annular configuration.

Here, the shaft region preferably has a polygonal, in particular hexagonal external contour. Here, the individual corner regions of the external contour form the protruding shaped elements. If a hexagonal external contour is selected, the shaft is configured in the manner of a hexagonal nut. The restriction to a few corner regions, for example to four to eight corner regions, first achieves reliable axial securing which withstands high pulling-out forces. Second, the necessary shearing force is kept low here by the limitation to a small number of corner regions which are to be sheared off.

Those boundaries of the shaped elements or the corner regions which lie on the outside in the radial direction define an outer circle. In one preferred refinement, the diameter of the latter is smaller than or equal to the diameter of a further outer circle which is defined by the component hole. That is to say, the maximum external diameter of the shaft is dimensioned in such a way that the shaft can be guided through the component hole without deformation of the component. In contrast with what are known as knurled nuts which have knurling on their external circumference and which form a form-fitting connection with the hole inner wall of the component hole as an antirotation safeguard, insertion into the component hole without deformation is provided here.

In order, in addition to axial securing, to also ensure at the same time an antirotation safeguard of the joining element with regard to the component, the component hole likewise has an external contour which deviates from the circular form and is adapted to the external contour of the shaft. A connection which is form-fitting in the rotational direction about the axial direction is formed between the component hole and the shaft, without deformation of the component taking place during the setting operation.

As an alternative or in addition to this antirotation safeguard, the individual securing lugs are molded into the component underside. A deformation process takes place here on the component underside, as a result of which a plurality of form-fitting connections which are active in the rotational direction are formed in a manner which is distributed over the circumference.

In order to achieve a sufficiently satisfactory antirotation safeguard here, the securing lugs which are adjacent to one another are spaced apart from one another. Here, the spacing is preferably at least half of the width of the securing lugs, as viewed in the circumferential direction. Securing webs are therefore formed on the perforated wall between the securing lugs which follow one another, which securing webs have a sufficient web width, in order for it to be possible for the required rotational forces for the antirotation safeguard to be absorbed.

Furthermore, there is provision in one preferred refinement for the component to remain non-deformed as a result of the setting operation of the joining element, in the region of the securing lugs and preferably overall. In comparison with the initial state without the inserted joining element, the component is therefore subjected to no shape change. This is advantageous, in particular, in high precision and very high position components, in which there would otherwise be the risk that warping in the component and therefore component inaccuracies could be produced by the setting operation of the joining elements. This is also advantageous in the case of high strength and very high strength components, in which a deformation is not possible or only possible with difficulty.

Furthermore, the object is achieved according to the invention by a joining element for a joined connection of this type, the shaft of the joining element having a polygonal, in particular hexagonal external contour. The advantages which are produced with regard to the joined connection and preferred refinements are to be applied to the joining element in an analogous manner.

It is also true for the method that the advantages which are specified with regard to the joined connection and preferred refinements are to be transferred to the method in an analogous manner.

The template has a hole, into which that part of the joining element which protrudes beyond the component underside dips during production of the joined connection. At the same time, the front template end has a shearing region, with the aid of which the partial shearing off takes place. According to one expedient development, the shearing region is configured as a shearing ring which protrudes beyond a template upper side. As a result of this measure, the template therefore penetrates more deeply into the component and, in comparison with a template having a flat template upper side, more material is sheared off and displaced and the displaced material penetrates more deeply into the component.

The hole in the shearing region of the template preferably tapers toward its front end, in particular conically. As a result of this measure, only a small part region of the hole wall is in contact with the shaft and a cavity is formed between the hole wall and the shaft. As a result of this, the pulling-out forces during withdrawing of the template are kept low after a setting operation has taken place.

As an alternative to the refinement, in which the shaft has protruding shaped elements or corner regions, the template has individual shearing webs in one expedient refinement, which shearing webs are distributed on the hole wall and shear off and displace shaft material in order to form the individual discrete securing lugs. A shearing contour which deviates from the circular shape is therefore formed on the template. In this variant, the shaft region preferably has a circular external contour.

Other features which are considered as characteristic for the invention are set forth in the appended claims.

Although the invention is illustrated and described herein as embodied in a joined connection, a joining element and a method for inserting a joining element into a component, it is nevertheless not intended to be limited to the details shown, since various modifications and structural changes may be made therein without departing from the spirit of the invention and within the scope and range of equivalents of the claims.

### BRIEF DESCRIPTION OF THE DRAWINGS

FIG. 1 is a diagrammatic sectional view through a joined connection between a component and a bolt-shaped joining element;

FIGS. 2A-2C are diagrammatic, sectional views through the joining element and the component according to FIG. 1 and a template in different stages during a setting operation of the joining element;

FIG. 3 is a diagrammatic, sectional view as in FIG. 2C, with the template according to a first alternative;

FIG. 4 is a diagrammatic, sectional view as in FIG. 2C, with the template according to a second alternative;

FIG. 5A is a diagrammatic, plan view of the joining element having a hexagonal shaft region;

FIG. 5B is a diagrammatic, side view of the joining element having the hexagonal shaft region;

FIG. 6A is a diagrammatic, plan view of a component upper side having a round component hole;

FIG. 6B is a diagrammatic, plan view of the component upper side having a hexagonal component hole;

FIG. 7A is a diagrammatic, perspective view of the joining element having a circular shaft region with individual securing lugs;

FIG. 7B is a diagrammatic, plan view of the template having individual discrete shearing webs; and

FIG. 7C is a diagrammatic, cross-sectional view of the joining element shown in FIG. 7A together with the template according to FIG. 7B, in the inserted state in a component at the end of the setting operation.

### DESCRIPTION OF THE PREFERRED EMBODIMENTS

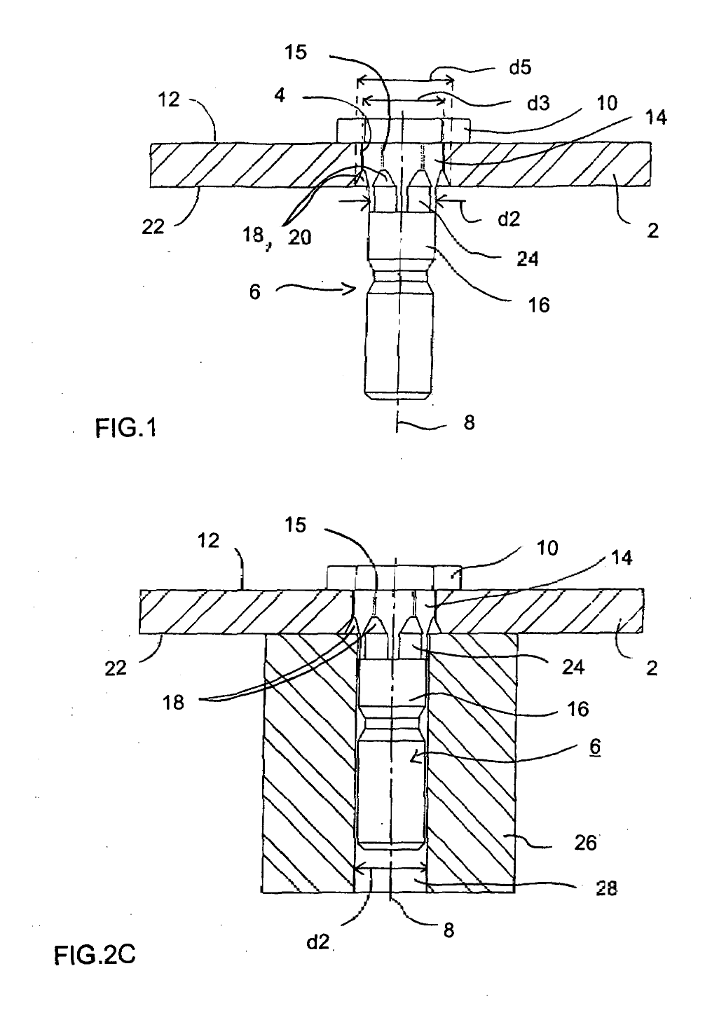

Referring now to the figures of the drawing in detail and first, particularly, to FIG. 1 thereof, there is shown a joined connection formed of a component 2 having a component hole 4, into which a joining element 6 which is configured as a bolt is inserted and which forms a form-fitting connection with the component 2 both in an axial direction 8 and also in a rotational direction about the axial direction 8. The component 2 and the joining element 6 are preferably composed of stainless steel.

The joining element 6 contains a head region 10 and, in a set state, lies with its head underside on a component upper side 12. The head region 10 is adjoined in the axial direction 8 by a shaft region 14 having a non-round external contour. In the exemplary embodiment, the shaft region 14 has a hexagonal external contour having a total of six corner regions 15 which extend in the axial direction 8. The shaft region 14 is adjoined by a bolt section 16 which has, for example, a thread (not shown here in greater detail). A further component can be fastened to the joining element 6. The joining element 6 is configured as what is known as a press-in bolt.

A plurality of securing lugs 18 are formed circumferentially on the shaft region 14 for axial securing. The securing lugs 18 have a cross-sectional or base surface which is triangular or trapezoidal as viewed in cross section. The securing lugs 18 are formed during production of the joined connection by partial shearing off of shaft material 20 and displacement of the latter against a component lower side 22. Here, in the exemplary embodiment, the securing lugs 18 are pressed into an inner wall of the component hole 4 in order to form an antirotation safeguard, that is to say the securing lugs 18 have deformed the component hole 4 during production of the joined connection in the lower region of the component hole 4. The securing lugs 18 are disposed individually in the circumferential direction and are spaced apart from one another. Here, the spacing is approximately the width of the individual securing lugs 18 on their base side which faces away from the head region 10.

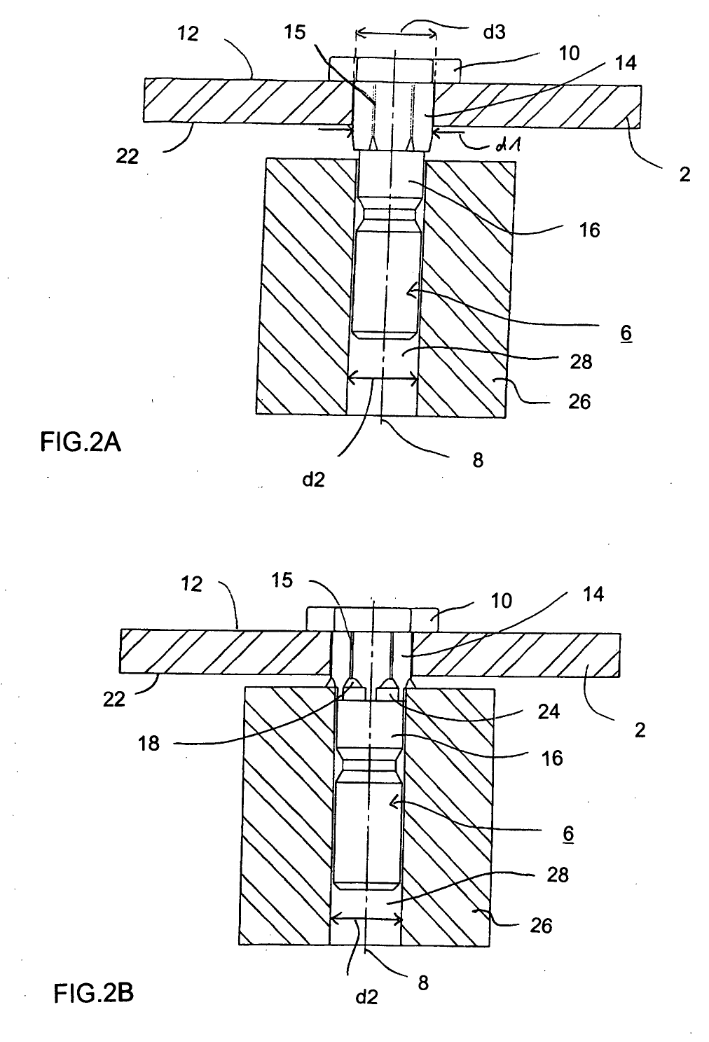

On account of the thickened portion which is caused by the shearing off in comparison with the external diameter d1 of the shaft region 14 in the initial state (see FIG. 2A), a form-fitting connection which acts in the axial direction is also produced at the same time. The component 2 is therefore clamped in fixedly in terms of rotation between the securing lugs 18 and the head region 10. In the exemplary embodiment of FIG. 1, the securing lugs 18 end flushly with the component underside 22.

As a result of the shearing off of the shaft material 20, shearing faces 24 are formed below the securing lugs 18, as viewed in the axial direction 8. As viewed in cross section, the shearing faces 24 lie on a circular line of a circle having a diameter d2 which is smaller than d1 and corresponds to the internal diameter of a hole 28 of a template 26, with the aid of which the securing lugs 18 are formed.

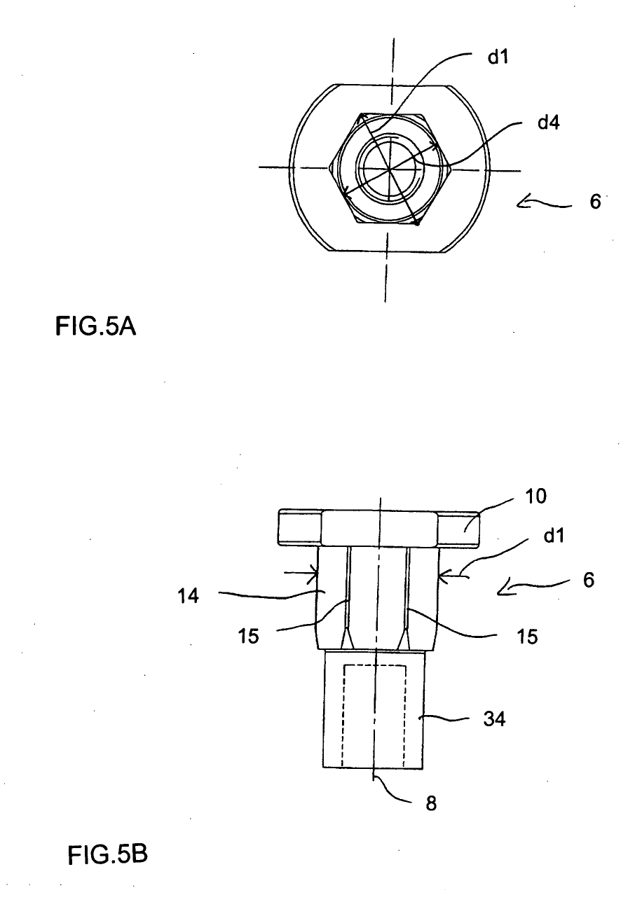

The setting method will be explained in the following text using FIGS. 2A-2C. First, the joining element 6 is inserted into the component hole 4. The component hole has a diameter d3 which is greater than or equal to the external diameter d1 of the shaft region 14. Subsequently, a template 26 is moved against the component 2. The bolt section 16 dips into the cylindrical hole 28 of the template 26. In the exemplary embodiment of FIGS. 2A-2C, the hole 28 has a constant internal diameter d2 which is smaller than the external diameter d1 of the shaft region 14. At the same time, the diameter d2 is greater than an internal diameter d4 of the shaft region 14 (see FIG. 5A). Here, the internal diameter is defined by the minimum spacing of the faces of the shaft region 14 which lie opposite one another. The relationship d4<d2<d1 is therefore valid, the diameters preferably being adapted to one another in such a way that d2−d4<(d1−d4), that is to say the internal diameter d2 of the hole lies closer to the internal diameter d4 than to the external diameter of the shaft region 14.

As a result of these diameter relationships, the corner regions 15 are therefore sheared off partially, the partially sheared off shaft material 20 is pushed by the template 26 in front of itself against the component underside 22 and is also pressed into the component 2 in the exemplary embodiment. Here, the shaft region 14 dips into the hole 28 by a shearing depth. The shearing depth corresponds to the length of the shearing faces 24 in the axial direction. Finally, the template 26 comes into contact with the component underside 22 by way of its front side, and the pressing-in operation is ended. During the pressing-in operation, the head region 10 is held counter to the feed movement of the template 26 with the aid of a non-illustrated supporting device. Subsequently, the template 26 is pulled off from the shaft region 14 and from the bolt section 16 again.

The diameter relationships and the shearing depth are then adapted to one another in such a way that an external diameter d5 which is formed in the set final state by the securing lugs 18 is preferably approximately from 10 to 30% and, in particular, 20% greater than the external diameter d3 of the component hole 4. As a result of this, a reliable axial form-fitting connection is produced which also withstands high pulling-out forces.

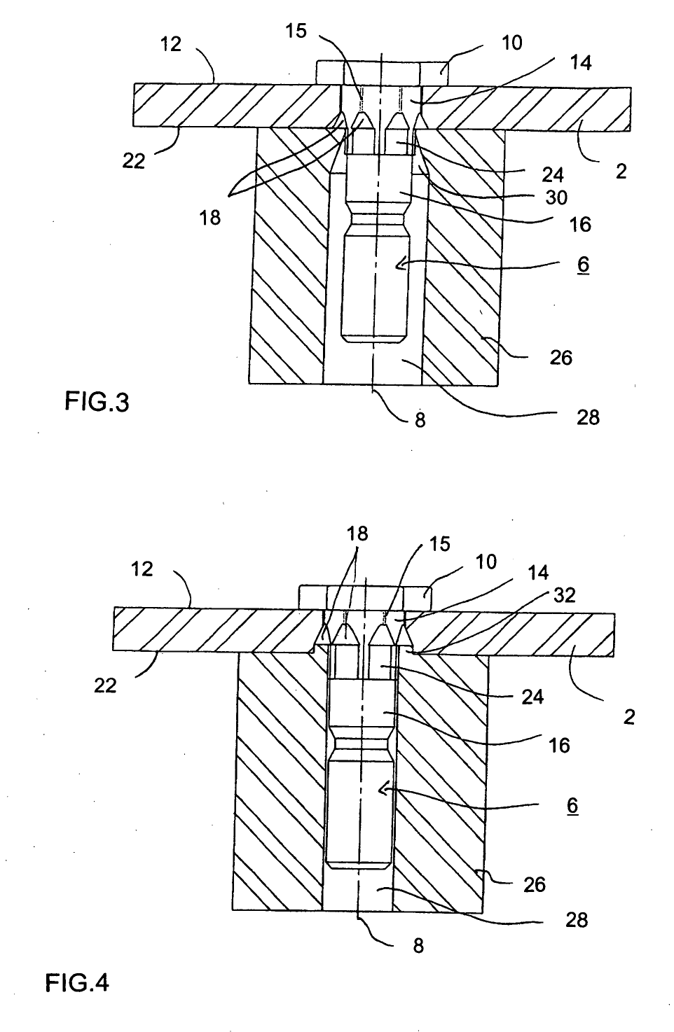

In the variant according to FIG. 3, there is provision for the hole 28 of the template 26 to taper conically toward the front, that is to say the hole 28 has its smallest internal diameter in the front shearing region of the template 26, by way of which the shearing is performed. A cavity 30 is therefore formed between the hole inner wall and the shaft region 14 or bolt section 16 outside the shearing region. There is therefore only a very small annular or linear contact area between the template 26 and the shaft region 14, with the result that the friction forces during withdrawal of the template 26 and therefore the pulling-out forces which act on the joining element 6 during withdrawal of the template are as small as possible.

In a further alternative refinement of the template 26 according to FIG. 4, the template 26 has, in the front shearing region, a circumferential shearing ring 32 which protrudes beyond the remaining end face of the template 26. As a result of this measure, the securing lugs 18 are pushed further into the component 2, with the result that the security against rotation and pressing out is increased.

The preferred hexagonal external contour of the shaft region 14 which is configured in the manner of a nut can be gathered again from FIGS. 5A, 5B. Instead of the bolt section 16 of the preceding exemplary embodiments, the joining element according to FIGS. 5A, 5B then contains a sleeve section 34 which adjoins the shaft region 14 and in which an internal thread is preferably formed. In a further alternative refinement, the joining element 6 overall is configured as a press-in nut, in which the shaft region 14 itself is formed as a sleeve having an internal thread.

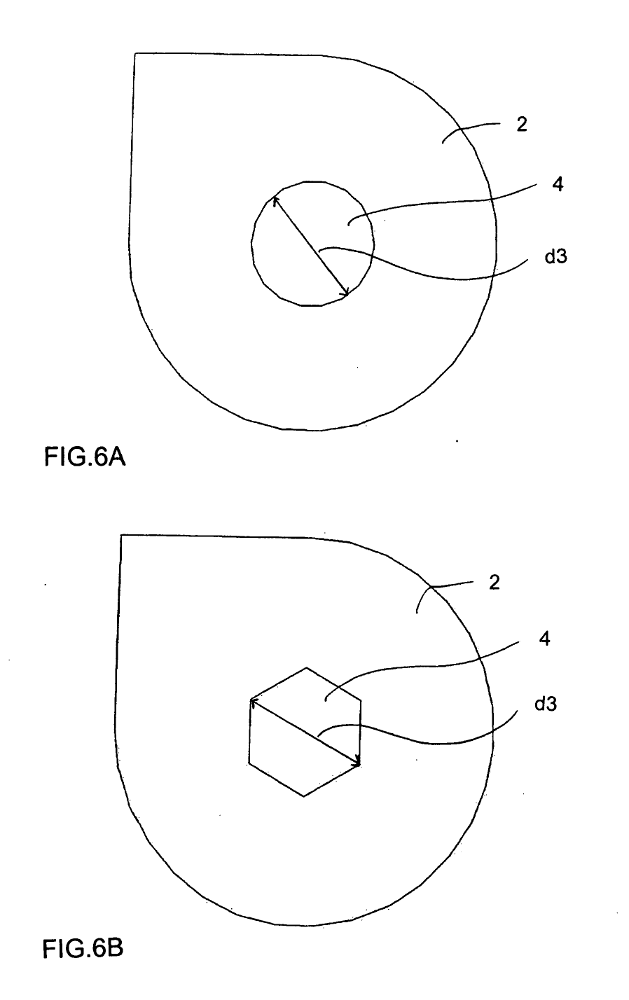

Two different cross-sectional geometries of the component hole 4 can be gathered from the plan views of the component 2 according to FIGS. 6A, 6B. According to FIG. 6A, the component hole 4 is of circular configuration. This variant is preferably used for components 2 which can be deformed and in which deformation of the component 2 is not critical. In this case, the securing lugs 18 are pressed into the component 2, as shown in FIGS. 1-4, in order to ensure an antirotation safeguard.

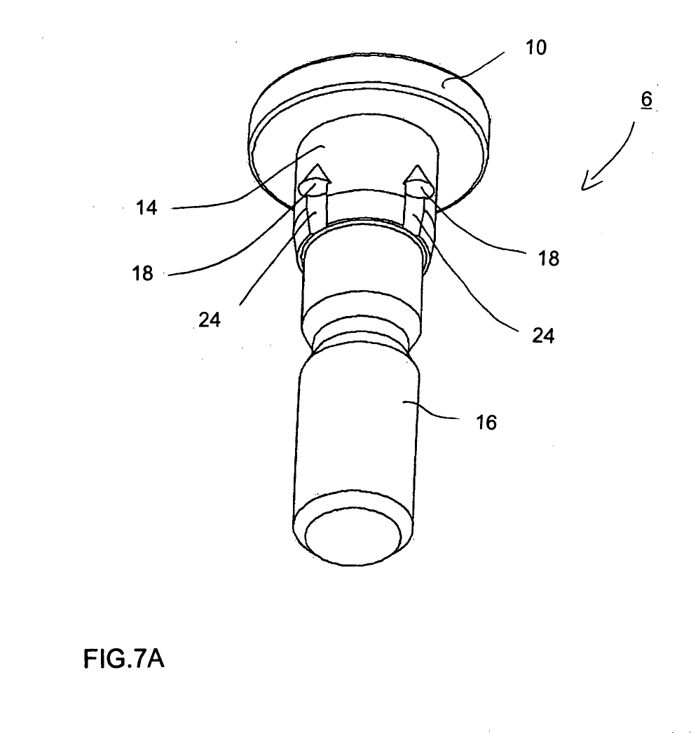

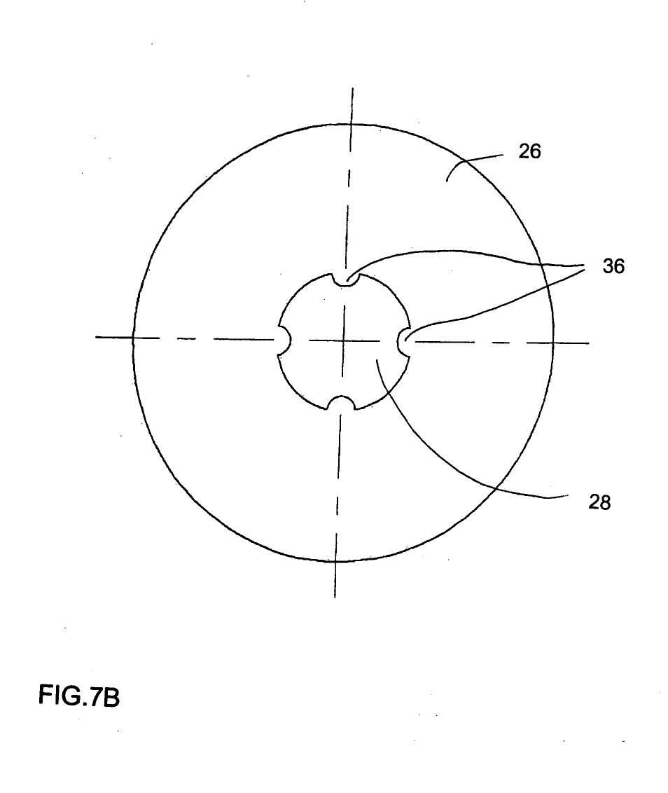

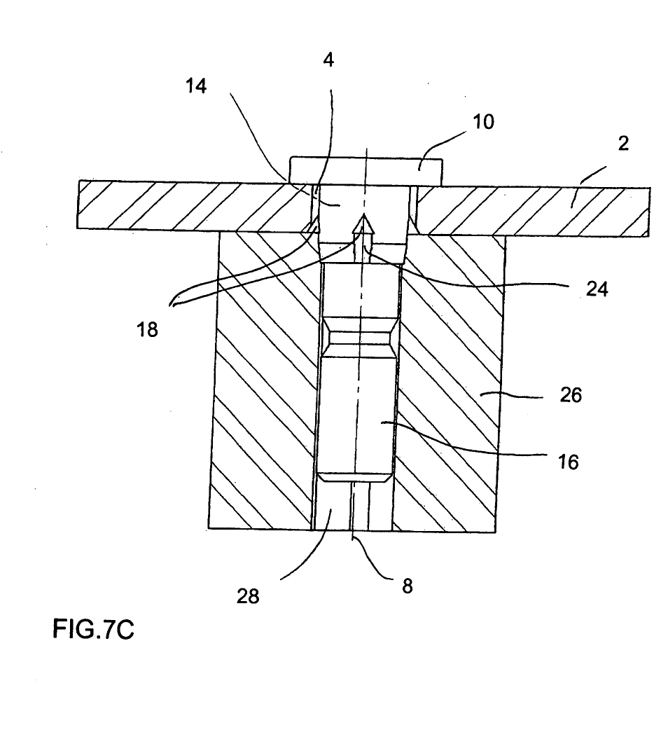

In contrast with this, in the exemplary embodiment according to FIG. 6B, the external contour of the component hole 4 is likewise hexagonal, like that of the shaft region, with the result that an antirotation safeguard is already achieved on account of the adapted external contours, without deformation of the component 2 being necessary. Apart from an installation play, the dimensions of the component hole 4 correspond to those of the shaft region 14. FIG. 7A shows the state of the joining element 6 having the securing lugs 18 which are formed after the setting operation. The shaft region 14 is cylindrical in the initial state. The securing lugs 18 have a conical geometry.

In the design variant according to FIGS. 7A-7C, the shaft region 14 is then of circular configuration, as viewed in cross section, and the template 26 has radially inwardly oriented projections which form shearing webs 36, in a deviation from the previously described circular geometry of the hole 28. The shearing webs 36 shear off the shaft material 20 partially during the pressing-in operation of the joining element 6 and form the securing lugs 28.

The method which is described here and the joined connection are suitable, in particular, for component pairings, in which sufficient deformation of the joining element 6 and/or the component 2 in order to produce the form-fitting connection is not possible. In particular, this method is suitable for a joined connection between the joining element 6 which is composed of stainless steel and the component 2 which likewise is composed of stainless steel.

1. A joined connection, comprising:
a component having a component hole formed therein and a component underside; and
a joining element having shaft material and inserted into said component hole in a form-fitting manner, an axial form-fitting securing being produced by a partial shearing off of said shaft material of said joining element and displacement of said shaft material against said component underside of said component.

2. The joined connection according to claim 1, wherein said joining element has:
a shaft region having a circumference; and
a plurality of securing lugs formed distributed about said circumference of said shaft region.

3. The joined connection according to claim 2, wherein said shaft region has an external contour deviating from a circular shape and protruding shaped elements which are sheared off partially.

4. The joined connection according to claim 3, wherein said shaft region has a polygonal external contour and corner regions forming said protruding shaped elements.

5. The joined connection according to claim 3, wherein said protruding shaped elements define a first outer circle having a diameter which is smaller than or equal to a diameter of a second outer circle defined by said component hole.

6. The joined connection according to claim 3, wherein said component hole defines an external contour adapted, as an antirotation safeguard, to said external contour of said shaft region which deviates from said circular shape.

7. The joined connection according to claim 2, wherein said securing lugs are molded into said component underside.

8. The joined connection according to claim 2, wherein said securing lugs are adjacent to one another and are spaced apart from one another.

9. The joined connection according to claim 1, wherein said component is not deformed.

10. A joining element for forming a joined connection with a component having a component hole formed therein and a component underside, the joining element comprising:
a shaft region having a polygonal contour and shaft material, said shaft region to be inserted into the component hole in a form-fitting manner, an axial form-fitting securing being produced by a partial shearing off of said shaft material of said shaft region and displacement of said shaft material against the component underside of the component.

11. The joining element according to claim 10, wherein said polygonal contour is a hexagonal external contour.

12. An insertion method, which comprises the step of:
providing a component having a component hole formed therein, providing a joining element having a shaft region formed of shaft material;
inserting the joining element, being inserted by way of the shaft region, into the component hole; and
pressing-in the joining element against a template for producing an axial form-fitting securing by the shaft material being severed partially at an external circumference of the shaft region during the pressing-in and being displaced toward the component for producing the axial form-fitting securing.

13. The method according to claim 12, which further comprises shearing off the shaft material with an aid of a protruding shearing ring.

14. The method according to claim 12, which further comprises forming a hole in the template for receiving the shaft region, the hole of the template tapering toward a front template end which performs a shearing off.

15. The method according to claim 12, which further comprises forming the template with a shearing contour which deviates from a circular shape, and has regions which protrude beyond the circular shape forming shearing webs for partial shearing off.

16. A joined connection between a component having a component hole formed therein and a component underside, and a joining element inserted into the component hole in a form-fitting manner, the joined connection comprising:
an axial form-fitting securing formed by a partial shearing off of shaft material of the joining element and displacement of said shaft material against the component underside of the component.

17. The joined connection according to claim 16, wherein the joining element has:
a shaft region having a circumference; and
a plurality of securing lugs formed distributed about said circumference of said shaft region, said plurality of securing lugs formed from said shaft material.

18. The joined connection according to claim 17, wherein said shaft region has an external contour deviating from a circular shape and protruding shaped elements which are sheared off partially.

19. The joined connection according to claim 18, wherein said shaft region has a polygonal external contour and corner regions forming said protruding shaped elements.

20. The joined connection according to claim 18, wherein said protruding shaped elements define a first outer circle having a diameter which is smaller than or equal to a diameter of a second outer circle defined by said component hole.

21. The joined connection according to claim 18, wherein the component hole defines an external contour adapted, as an antirotation safeguard, to said external contour of said shaft region which deviates from said circular shape.

22. The joined connection according to claim 17, wherein said securing lugs are molded into the component underside.

23. The joined connection according to claim 18, wherein said securing lugs are adjacent to one another and are spaced apart from one another.

24. The joined connection according to claim 16, wherein said component is not deformed.
